(19) United States
(12) Patent Application Publication
(10) Pub. No.: US 2020/0190303 A1
(43) Pub. Date: Jun. 18, 2020

(54) POLYOLEFIN COMPOSITION WITH REDUCED ODOR AND FOGGING

(71) Applicant: BASELL POLIOLEFINE ITALIA S.R.L., MILANO (IT)

(72) Inventors: JUERGEN ROHRMANN, KELKHEIM (DE); MIKHAIL SERGEEVICH DUREEV, BUTZBACH (DE)

(73) Assignee: BASELL POLIOLEFINE ITALIA S.R.L., MILANO (IT)

(21) Appl. No.: 16/621,104

(22) PCT Filed: Jun. 8, 2018
(86) PCT No.: PCT/EP2018/065108

§ 371 Date: Dec. 10, 2019

(30) Foreign Application Priority Data
Jun. 13, 2017 (EP) 17175795.8

(51) Int. Cl. C08L 23/12

(52) U.S. Cl. CPC C08L 23/12; C08L 2205/025; C08L 2207/062; C08L 2205/08; C08L 2207/02; C08L 2205/035

(57) ABSTRACT

A polyolefin composition made from or containing (A) at least one polyolefin, (B) up to 50.0% by weight of a filler, and (C) from 0.05 to 2.5% by weight of at least one cyclodextrin, wherein the sum of (A)+(B)+(C) is equal to 100 weight percent, based on the total weight of the polyolefin composition.

### FIELD OF THE INVENTION

In general, the present disclosure relates to the field of chemistry. More specifically, the present disclosure relates to polymer chemistry. In particular, the present disclosure relates to polyolefin compositions, articles made therefrom, and processes for molding the polyolefin compositions.

### BACKGROUND OF THE INVENTION

Original equipment manufacturers (OEMs) have rigorous odor specifications on interior applications and heating and air conditioning units.

A method to determine odor is VDA 270, wherein a sample is heated in a small closed flask and then subjected to an odor detection test. The ranking is made on a scale from 1 (no smell) to 6 (extremely high odor). Many OEMs have set the limits for odor at less than 3. It is believed that most commercial polypropylene compounds fail to reach a value less than 3. It is further believed that to achieve long term heat stability, UV resistance, scratch performance, surface quality, haptics and mechanical properties in automobiles, many additives and fillers are used; unfortunately, those additives and fillers adversely affect smell.

While stripping additives remove volatile organic substances during compounding, the stripping additives are inefficient and negatively impact long term heat stability, UV resistance and scratch performance.

While absorbers reduce odor by absorbing odor-causing molecules, absorbers are likewise inefficient and negatively impact overall performance.

While optimization of compounding and injection molding conditions may reduce odor, the process modifications have limited efficacy and increase the cost for compounding and injection molding due to lower throughput and higher cycle times.

An additional consideration for OEMs relates to the prevention or reduction of fogging. As used herein, the term “fogging” refers to the evaporation of volatile components of polymers, textiles and leather.

In some instances, high temperatures cause the volatile components to evaporate and condense in fine droplets on the internal surfaces, including the windscreen.

At the same time the materials used become more brittle and harder as the volatile components evaporate resulting in material fatigue and premature aging.

In some instances, methods for reducing fogging are aimed at lowering the surface tension of the substrate or a water-absorptive compound, by treating with a water-repellent compound, nanostructuring the surface, or warming the substrate.

### SUMMARY OF THE INVENTION

In a general embodiment, the present disclosure relates to a polyolefin composition. In a general embodiment, the present disclosure relates to a molded article. In a general embodiment, the present disclosure relates to an injection molding process including the step of molding the polyolefin composition.

In some embodiments, the polyolefin composition of the present disclosure is made from or contains:

(A) at least one polyolefin;
(B) up to 50.00%, alternatively from 3.00 to 40.00%, alternatively from 5.00 to 38.00%, alternatively from 10.00 to 35.00% by weight of a filler; and
(C) from 0.05 to 2.50%, alternatively from 0.10 to 2.50%, alternatively from 0.20 to 2.00%, alternatively from 0.30 to 1.50% by weight of at least one cyclodextrin, wherein the sum (A)+(B)+(C) being 100.
While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the detailed description is to be incorporated as illustrative in nature and not restrictive.

### DETAILED DESCRIPTION OF THE INVENTION

In some embodiments, component (A) is made from or contains at least one polypropylene. In some embodiments, the polypropylene is a propylene homopolymer, a heterophasic propylene copolymer, a random propylene copolymer or a mixture thereof, alternatively component (A) is made from or contains at least one heterophasic propylene copolymer or at least one polypropylene homopolymer or a mixture thereof.

Heterophasic propylene copolymers are made from or contain a matrix being a propylene homopolymer or a random propylene copolymer wherein an amorphous phase, which contains a propylene ethylene copolymer rubber (elastomer), is dispersed. The polypropylene matrix contains dispersed inclusions not being part of the matrix and the inclusions contain the elastomer. As used herein, the term “inclusion” indicates that the matrix and the inclusion form different phases within the heterophasic propylene. In some embodiments, the heterophasic polypropylene contains a crystalline polyethylene, which is a by-reaction product obtained by the preparation of the heterophasic propylene copolymer. It is believed that the crystalline polyethylene is present as inclusion of the amorphous phase due to thermodynamic reasons.

In some embodiments, component (A) is made from or contains:

(A1) from 60.00 to 100%, alternatively from 65.00 to 85.00% by weight of at least one heterophasic propylene copolymer or at least a polypropylene homopolymer or a mixture thereof;
(A2) from 0 to 25.00%, alternatively from 1.00 to 8.00% by weight of one or more polyethylenes, alternatively a high density polyethylene having density ranging from 0.93 to 0.97 g/cm³; and
(A3) from 0 to 15.00 wt %, alternatively from 5.00 to 10.00% by weight of one or more copolymers of ethylene and one monomer selected from 1-butene, 1-hexene or 1-octene containing from 15 wt % to 60 wt % alternatively from 20 wt % to 40 wt %, alternatively from 25 wt % to 35 wt % of 1-butene or 1-octene derived units. In some embodiments, the copolymer has a MFR (measured at 190° C., 2.16 kg load) between 0.5 g/10 min and 35.0 g/10 min; alternatively from 1.0 g/10 min to 10.0 g/10 min. The sum (A1)+(A2)+(A3) being 100.

Cyclodextrins (CDs) are cyclic oligomers of glucose formed by enzymes. In some embodiments, the enzyme is cyclodextrin glycosyltransferase (CGTase). In some embodiments, the cyclodextrins belong to oligosaccharides. In some embodiments, the cyclodextrins contain 6, 7, or 8 glucose monomers joined by alpha-1,4 linkages. To some persons skilled in the art, these oligomers are called α-cyclodextrin (α-CD), β-cyclodextrin (β-CD), and γ-cyclodextrin (γ-CD), respectively. Each glucose unit has three hydroxyl groups each at the 2, 3, and 6 positions. Hence, α-CD has 18 hydroxyls or 18 substitution sites available and may have a maximum degree of substitution (DS) of 18. Similarly, β-CD and γ-CD have a maximum DS of 21 and 24, respectively.

In some embodiments, a stable three-dimensional molecular configuration for these oligosaccharides is referred to herein as a “toroid,” which is a doughnut or coil-like (torus) shape with the smaller and larger openings of the toroid presenting primary and secondary hydroxyl groups. It is believed that the specific coupling of the glucose monomers gives the CD molecule a rigid, truncated conical molecular structure with a hollow interior of a specific volume.

This internal cavity, which is lipophilic (that is, attractive to hydrocarbon materials when compared to the exterior surface), is a structural feature of cyclodextrin. It is believed that the lipophilic features enables the cyclodextrin to complex molecules of the type selected from the group consisting of aromatics, alcohols, halides, hydrogen halides, carboxylic acids, and esters, among others. It is believed that the complexed molecule should be of a size of at least partially fitting into the cyclodextrin internal cavity for forming an inclusion complex.

In some embodiments, the cyclodextrin is selected from the group consisting of β-cyclodextrin, methylated β-cyclodextrin and a mixture between β-cyclodextrin and methylated β-cyclodextrin.

In some embodiments, a filler (B) is included in the composition. The filler can be organic or inorganic.

In some embodiments, the fillers are fibers. In some embodiment, inorganic fillers are selected from the group consisting of metallic flakes, glass flakes, milled glass, glass spheres and mineral fillers. In some embodiments, mineral fillers are selected from the group consisting of talc, calcium carbonate, mica, wollastonite, silicates, kaolin, barium sulfate, metal oxides and hydroxides such as magnesium hydroxide, or a mixture of these.

In some embodiments, the fibers are made of glass, metal, ceramic, graphite, and organic polymers such as polyesters and nylons. In some embodiments, the fibers are aramids.

Another suited filler is wood flour, alone or in mixture with the other types of fillers.

In some embodiments, the fillers are talc and glass fibers.

In some embodiments, the glass fibers are milled or chopped short glass fibers or long glass fibers. In some embodiments, the glass fibers are in the form of continuous filament fibers. As used herein, the terms “chopped glass fibers,” “short glass fibers” and “chopped strands” are used interchangeably.

In some embodiments, the composition is further made from or contains a compatibilizer.

As used herein, the term “compatibilizer” refers to a component capable of improving the interfacial properties between fillers and polymers by reducing the interfacial tension between fillers and polymers while simultaneously reducing the agglomeration tendency of filler particles, thereby improving dispersion of the filler particles within the polymer matrix.

In some embodiments, the compatibilizer is a low molecular weight compound having reactive polar groups which increase the polarity of polyolefin. In some embodiments, the reactive polar groups react with functionalized coating or sizing of fillers, thereby enhancing the compatibility with the polyolefin itself. In some embodiments, the functionalizing groups for the fillers are silanes. In some embodiments, the silanes are selected from the group consisting of aminosilanes, epoxysilanes, amidosilanes and acrylosilanes. In some embodiments, the silane is an aminosilane.

In some embodiments, the compatibilizers is made from or contains a polymer modified (functionalized) with polar moieties and, optionally, a low molecular weight compound having reactive polar groups. In some embodiments, the compatibilizers are made from or contain modified olefin polymers. In some embodiments, the olefin polymers are propylene homopolymers and copolymers, alternatively copolymers of ethylene and propylene with optionally other alpha olefins. In some embodiments, the modified olefin polymers are modified polyethylene or polybutene.

In some embodiments and in terms of structure, the modified polymers are selected from graft or block copolymers. In some embodiments, the modified polymers contain groups deriving from polar compounds, alternatively selected from acid anhydrides, carboxylic acids, carboxylic acid derivatives, primary and secondary amines, hydroxyl compounds, oxazoline and epoxides, and ionic compounds.

In some embodiments, the polar compounds are selected from the group consisting of unsaturated cyclic anhydrides, aliphatic diesters, and diacid derivatives. In some embodiments, the polar compounds are selected from the group consisting of maleic anhydride and compounds selected from C₁-C₁₀ linear and branched dialkyl maleates, C₁-C₁₀ linear and branched dialkyl fumarates, itaconic anhydride, C₁-C₁₀ linear and branched itaconic acid dialkyl esters, maleic acid, fumaric acid, itaconic acid and mixtures thereof.

In some embodiments, the compatibilizer is in an amount ranging from 0.1 up to 5.0 wt % with respect to the sum (A)+(B).

In some embodiments, the amount of groups deriving from polar compounds in the modified polymers ranges from 0.3 to 3% by weight, alternatively from 0.3 to 1.5 wt %.

In some embodiments, a propylene polymer grafted with maleic anhydride is the compatibilizer.

In some embodiments, the filler is a glass fiber, the composition further is made from or contains a compatibilizer, being a propylene polymer grafted with maleic anhydride.

In some embodiments, the composition is used for the production of injection molded articles. In some embodiments, the injection molded articles are selected from the group consisting of automotive articles, pipes and fibers for textile applications.

The following examples are given to illustrate the present disclosure without any limiting purpose.

### Measurement Methods

The characterization data for the compositions of the disclosure were obtained according to the following methods:

Melt Flow Rate (MFR)

Determined according to ISO 1133 (230° C., 2.16 kg), unless otherwise specified.

Melt Volume Rate (MVR)

Determined according to ISO 1133 (230° C., 2.16 kg).

Ash Content

Determined according to ISO 3451/1, 1 hour at 625° C.

Flexural Modulus, Flexural Strength at 3.5%, Strain, Flexural Strength at Yield, Elongation at Flexural Strength

Determined according to ISO method 178 on rectangular specimens (80×10×4 mm) from T-bars (ISO 527-1, Type 1A).

Tensile Modulus, Tensile Stress at Yield, Tensile Strength, Tensile Stress at Break, Elongation at Break

Determined according to ISO method 178 on rectangular specimens (80×10×4 mm) from T-bars (ISO 527-1, Type 1A).

Charpy Impact Test

Determined according to ISO 179/1eU and/1eA on rectangular specimens (80×10×4 mm) from T-bars (ISO 527-1, Type 1A).

C-Emission

Determined on granules according to VDA 277.

Volatile Organic Compounds (VOCs)

VOC amounts (highly and medium volatile compounds) were determined according to VDA 278.

FOG

FOG (low volatile compounds) were determined according to VDA 278.

Long-Term Heat Stability

Determined at 150° C. according to IEC 60216/4 (VW 44045).

Fogging

Determined according to DIN 75201 with the gravimetric method (DIN 75201/B).

Odor

Odor was established according to VDA 270 by two panels of people. The rating is based on a scale from 1 (no smell) to 6 (extremely high odor).

T-Bar Preparation (Injection Molded)

Determined according to ISO 1873-2 (1989).

### EXAMPLES

All compositions described in the examples were produced with a Krupp Werner & Pfleiderer/1973, ZSK 53 twin-screw extruder (screw diameter: 2×53, 36D; screw rotation speed of 150 rpm; melt temperature of 230° C.).

### Example 1—PP Composition with Talc

The composition was made with:

28.00 wt % of a heterophasic polypropylene (PP heco 1, C₂ content of 5.4 wt %, MFR 18 g/10 min);

28.00 wt % of a heterophasic polypropylene (PP heco 2, C₂ content of 10.0 wt %, MFR 70 g/10 min);

20.00 wt % of Steamic T1 C A talc from IMERYS (hydrated magnesium silicate, d50 (Sedigraph 5100)=2.0, lamellarity index=1.8));

11.00 wt % of an ethylene/1-butene plastomer (Engage™ 7467, from The Dow Chemical Company);

6.00 wt % of a high density polyethylene (HDPE, MFR (190° C./2.16 kg)=14 g/10 min);

2.65 wt % of a polypropylene homopolymer (PP homo 1, MFR=10 g/10 min);

0.50 wt % of β-cyclodextrin (CAVAMAX® W7, from Wacker Chemie); and

3.85 wt % of an additive package made from containing 0.15 wt % of magnesium oxide (Magnesium Oxide Remag AC, from Spaeter), 0.20 wt % of HALS stabilizer (Cyasorb® UV-3853 S, from Cytec), 0.50 wt % of GMS (Dimodan® HP, from Danisco), 0.50 wt % of erucamide (Kemamide® EZ powder, from PMC Biogenix Inc.), 0.40 wt % of antioxidants (0.20 wt % of Irgafos® 168 and 0.20 wt % of Irganox® 1010, from BASF), 2.00 wt % of a carbon black masterbatch, 40% by weight in polypropylene (BK MB-PP MB, 40% black, from Polyplast Müller) and 0.10 wt % polar wax (Licowax® OP powder, from Clariant) with respect to the total amount of the composition.

### Example 2—PP Composition with Talc

The composition of Example 2 was made with the same components and amounts as Example 1, except that the concentration of the polypropylene homopolymer (MFR=10 g/10 min) was 2.15 wt %, and the CAVAMAX® W7 β-cyclodextrin concentration was 1.00 wt %.

### Example 3—PP Composition with Talc

The composition of Example 3 was made with the same components and amounts as Example 1, except that the cyclodextrin used was CAVASOL® W7 M methyl-β-cyclodextrin from Wacker Chemie.

### Example 4—PP Composition with Talc

The composition of Example 4 was made with the same components and amounts as Example 3, except that the concentration of the polypropylene homopolymer (MFR=10 g/10 min) was 2.15 wt %, and the CAVASOL® W7 M methyl-β-cyclodextrin concentration was 1.00 wt %.

### Example 5—PP Composition with Talc

The composition of Example 5 was made with the same components and amounts as Example 3 except that the concentration of the polypropylene homopolymer (MFR=10 g/10 min) was 2.15 wt % and, instead of 1.00 wt % of CAVASOL W7 M methyl-β-cyclodextrin, 0.05 wt % of CAVAMAX W7 β-cyclodextrin and 0.05 wt % of CAVASOL W7 M methyl-β-cyclodextrin were used.

### Comparative Example 1—PP Composition with Talc

The composition of Comparative Example 1 was made with the same components and amounts as Example 1 except that the concentration of the polypropylene homopolymer (MFR=10 g/10 min) was 3.15 wt %, and no cyclodextrins were present.

The compositions of Examples 1-5 and Comparative Example 1 are reported in Table 1.

TABLE 1

| | | Comp Ex | | | | | |
|---|---|---|---|---|---|---|---|
| | | 1 | Ex 1 | Ex 2 | Ex 3 | Ex 4 | Ex 5 |
| PP heco 1 | [wt %] | 28.00 | 28.00 | 28.00 | 28.00 | 28.00 | 28.00 |
| PP heco 2 | [wt %] | 28.00 | 28.00 | 28.00 | 28.00 | 28.00 | 28.00 |
| Talc | [wt %] | 20.00 | 20.00 | 20.00 | 20.00 | 20.00 | 20.00 |
| Engage | [wt %] | 11.00 | 11.00 | 11.00 | 11.00 | 11.00 | 11.00 |
| 7467 | | | | | | | |
| HDPE | [wt %] | 6.00 | 6.00 | 6.00 | 6.00 | 6.00 | 6.00 |
| PP homo 1 | [wt %] | 3.15 | 2.65 | 2.15 | 2.65 | 2.15 | 2.15 |
| CAVAMAX | [wt %] | 0 | 0.50 | 1.00 | 0 | 0 | 0.50 |
| W7 | | | | | | | |
| CAVASOL | [wt %] | 0 | 0 | 0 | 0.50 | 1.00 | 0.50 |
| W7M | | | | | | | |
| Additive | [wt %] | 3.85 | 3.85 | 3.85 | 3.85 | 3.85 | 3.85 |
| package | | | | | | | |

The properties of Examples 1-5 and Comparative Example 1 are reported in Table 2.

TABLE 2

| | | Comp | | | | | |
|---|---|---|---|---|---|---|---|
| | | Ex 1 | Ex 1 | Ex 2 | Ex 3 | Ex 4 | Ex 5 |
| MFR | [g/10 min] | 18.6 | 18.8 | 18.4 | 17.7 | 17.1 | 17.8 |
| MVR | [g/10 min] | 21.6 | 21.9 | 21.4 | 20.6 | 19.8 | 20.7 |
| Ash content | [wt %] | 19.67 | 19.66 | 19.64 | 19.90 | 20.14 | 20.07 |
| Flexural | [N/mm²] | 1727 | 1714 | 1723 | 1780 | 1670 | 1680 |
| Modulus | | | | | | | |
| Charpy | [kJ/m²] | 26.5B/2 | 27.9 B/9 | 26.3 B | 26.9 B | 32.1 D | 28.0 B1 |
| notched | | 32.8 D/8 | 31.0 D/1 | | | | 30.9 D/9 |
| impact (23° C.) | | | | | | | |
| Charpy | [kJ/m²] | 7.08 B | 6.36 B | 6.16 B | 5.51 B | 7.26 B | 6.76 B |
| notched | | | | | | | |
| impact (0° C.) | | | | | | | |
| Charpy | [kJ/m²] | 4.05 B | 3.6 B | 3.14 B | 3.15 B | 3.58 B | 3.33 B |
| notched | | | | | | | |
| impact (−30 | | | | | | | |
| ° C.) | | | | | | | |
| C-emission | [μg/g] | 23 | 23 | 23 | 21 | 21 | 21 |
| Long-term | [h] | 504 | 504 | 528 | 696 | 504 | 672 |
| heat stability | | | | | | | |
| at 150° C. | | | | | | | |
| Odor, Panel 1 | [u.a.] | 4.0 | 3.3 | 3.2 | 2.8 | 3.0 | 3.0 |
| Odor, Panel 2 | [u.a.] | 3.5 | 3.2 | 3.0 | 2.7 | 2.7 | 2.3 |

### Example 6—PP Composition with Glass Fibers

The composition was made with:

40.47 wt % of a polypropylene homopolymer (PP homo 2, MFR=10 g/10 min);

26.00 wt % of a polypropylene homopolymer (PP homo 3, MFR=1400 g/10 min);

31.00 wt % of 13 micron chopped glass fibers (“GB,” ThermoFlow® EC 13 636 fiberglass, from Johns Manville);

0.50 wt % of a propylene homopolymer grafted with maleic anhydride (PP-g-MA, Exxelor™ PO1020, from ExxonMobil);

0.50 wt % of β-cyclodextrin (CAVAMAX® W7, from Wacker Chemie); and

1.58 wt % of an additive package made from or containing 0.20 wt % of magnesium oxide (Magnesium Oxide Remag AC, from Spaeter), 0.75 wt % of antioxidants (0.20 wt % of Irgafos® 168, 0.15 wt % of Irganox® 1010 and 0.40 wt % of Irganox® PS 802 FL, from BASF), 0.63 wt % of a carbon black masterbatch, 40% by weight polypropylene (BK MB-PP MB, 40% black, from Polyplast Müller) with respect to the total amount of the composition.

### Comparative Example 2—PP Composition with Glass Fibers

The composition of Comparative Example 2 was made with the same components and amounts as Example 6 except that the polypropylene homopolymer (PP homo 2) concentration was 40.97 wt %, and no cyclodextrins were present.

The compositions of Example 6 and Comparative Example 2 are reported in Table 3.

TABLE 3

| | | Comp Ex 2 | Ex 6 |
|---|---|---|---|
| PP homo 2 | [wt %] | 40.97 | 40.47 |
| PP homo 3 | [wt %] | 26.00 | 26.00 |
| GF | [wt %] | 31.00 | 31.00 |
| PP-g-MA | [wt %] | 0.50 | 0.50 |
| CAVASOL W7 | [wt %] | 0 | 0.50 |
| Additive package | [wt %] | 1.58 | 1.58 |

Properties of Example 6 and Comparative Example 2 are reported in Table 4.

TABLE 4

| | | Comp Ex 2 | Ex 6 |
|---|---|---|---|
| MFR | [g/10 min] | 16.5 | 16.2 |
| MVR | [g/10 min] | 17.6 | 17.3 |
| Ash content | [wt %] | 31.91 | 31.18 |
| Tensile modulus | [N/mm²] | 6929 | 6731 |
| Tensile stress | [N/mm²] | 99.4 | 95.7 |
| at yield | | | |
| Elongation | [%] | 2.6 | 2.7 |
| at yield | | | |
| Tensile strength | [N/mm²] | 98.9 | 95.9 |
| Tensile stress | [N/mm²] | 98.9 | 95.3 |
| at break | | | |
| Elongation at break | [%] | 2.8 | 2.9 |
| Charpy notched | [kJ/m²] | 9.97 | 9.51 |
| impact (23° C.) | | | |
| Charpy unnotched | [kJ/m²] | 46.8 | 48.8 |
| impact (0° C.) | | | |
| C-emission | [μg/g] | 4 | 3 |
| VOC | [ppm] | 28 | 27 |
| FOG | [ppm] | 153 | 146 |
| Long-term heat | [h] | 1200 | 1116 |
| stability at | | | |
| 150° C. | | | |
| Fogging | [mg] | 1.1 | 0.5 |
| Odor, Panel 1 | [u.a.] | 3.7 | 2.7 |
| Odor, Panel 2 | [u.a.] | 3.0 | 2.0 |

### Example 7—PP Unfilled Composition

The composition was made with:

94.00 wt % of a heterophasic polypropylene (PP heco 3, C₂ content of 9.0 wt %, MFR=12 g/10 min);

0.74 wt % of a polypropylene homopolymer (PP homo 4, MFR=1.2 g/10 min);

0.50 wt % of β-cyclodextrin (CAVAMAX® W7, from Wacker Chemie); and

4.76 wt % of an additive package made from or containing 1.50 wt % of nucleating talc (HTP1c, from IMI Fabi), 0.50 wt % of GMS (Dimodan® HP, from DuPont Danisco), 0.10 wt % of HALS stabilizer (Cyasorb® UV-3853 S, from Cytec), 0.60 wt % of antioxidants (0.20 wt % of Irgafos® 168 and 0.40 wt % of Irganox® 1010, from BASF), 0.20 wt % of nucleating agent (Palmarole MI.NA.08, from Akeka Palmarole), 0.20 wt % of magnesium oxide (Magnesium Oxide Remag AC, from Spaeter), 0.44 wt % of pigments (0.12 wt % of YL PI—Sicotan Yellow K2001 FG, from BASF, 0.04 wt % of RD PI—Colortherm Red 110 M, from Clariant, and 0.28 wt % of WT PI—Kronos 2220, from Kronos), and 1.22 wt % of a carbon black masterbatch, 40% by weight in polypropylene (BK MB-PP MB 40% black, from Polyplast Müller), with respect to the total amount of the composition.

### Example 8—PP Unfilled Composition

Composition of Example 8 was made with the same components and amounts of Example 7 except that that the cyclodextrin used was CAVASOL® W7 M methyl-β-cyclodextrin from Wacker Chemie.

### Comparative Example 3—PP Unfilled Composition

The composition of Comparative Example 3 was made with the same components and amounts as Example 7 except that the polypropylene homopolymer (PP homo 3) was 1.24 wt %, and no cyclodextrins were present.

Compositions of Examples 7 and 8 and Comparative Example 3 are reported in Table 5.

TABLE 5

| | | Comp Ex 3 | Ex 7 | Ex 8 |
|---|---|---|---|---|
| PP heco 3 | [wt %] | 94.00 | 94.00 | 94.00 |
| PP homo 4 | [wt %] | 1.24 | 0.74 | 0.74 |
| CAVASOL W7 | [wt %] | 0 | 0.50 | 0 |
| CAVASOL W7 M | [wt %] | 0 | 0 | 0.50 |
| Additive package | [wt %] | 4.76 | 4.76 | 4.76 |

Properties of Examples 7 and 8 and Comparative Example 3 are reported in Table 6.

TABLE 6

| | | Comp | | |
|---|---|---|---|---|
| | | Ex 2 | Ex 7 | Ex 8 |
| MFR | [g/10 min] | 13.2 | 13.6 | 13.4 |
| MVR | [g/10 min] | 17.9 | 18.3 | 18.1 |
| Ash content | [wt %] | 2.03 | 2.14 | 2.16 |
| Flexural modulus | [N/mm²] | 1431 | 1408 | 1319 |
| Charpy notched | [kJ/m²] | 12.11 B | 11.05 B | 13.02 B |
| impact (23° C.) | | | | |
| Charpy notched | [kJ/m²] | 6.83 B | 6.48 B | 6.71 B |
| impact (0° C.) | | | | |
| C-emission | [μg/g] | 9 | 8 | 8 |
| VOC | [ppm] | 58 | 51 | 54 |
| FOG | [ppm] | 239 | 237 | 250 |
| Fogging | [mg] | 1.4 | 0.9 | 0.9 |
| Odor, Panel 1 | [u.a.] | 4.3 | 4.2 | 3.7 |

What is claimed is:

1. A polyolefin composition comprising:
(A) at least one polyolefin;
(B) up to 50.0% by weight of a filler; and
(C) from 0.05 to 2.5% by weight of at least one cyclodextrin, the sum (A)+(B)+(C) being 100.

2. The polyolefin composition according to claim 1 comprising:
(A) at least one polyolefin;
(B) from 3.0 to 40.0% by weight of a filler; and
(C) from 0.1 to 2.5% by weight of at least one cyclodextrin, the sum (A)+(B)+(C) being 100.

3. The polyolefin composition according to claim 1 comprising:
(A) at least one polyolefin;
(B) from 5.0 to 38.0% by weight of a filler; and
(C) from 0.2 to 2.0% by weight of at least one cyclodextrin, the sum (A)+(B)+(C) being 100.

4. The polyolefin composition according to claim 1, wherein component (A) comprises a polypropylene.

5. The polyolefin composition according to claim 1, wherein the cyclodextrin is β-cyclodextrin, methylated β-cyclodextrin or a mixture thereof.

6. The polyolefin composition according to claim 1, wherein the filler (B) is talc.

7. The polyolefin composition according to claim 1, wherein the filler (B) is glass fibers.

8. The polyolefin composition according to claim 7 further comprising a compatibilizer.

9. The polyolefin composition according to claim 8, wherein the compatibilizer is a propylene polymer grafted with maleic anhydride.

10. A molded article prepared from the composition according to claim 1.

11. The molded article according to claim 10, being an automotive article.

12. A process for injection molding comprising the step of:
molding the polyolefin composition according to claim 1.
